(19) United States
(12) Patent Application Publication
(10) Pub. No.: US 2009/0317321 A1
(43) Pub. Date: Dec. 24, 2009

(54) DECOMPOSITION OF SPENT SULFURIC ACID USING OXYGEN

(76) Inventors: James Patrick Meagher, Buffalo, NY (US); William Thoru Kobayashi, East Amherst, NY (US); Maynard Guotsuen Ding, Yorktown Heights, NY (US); Lee Jonathan Rosen, Buffalo, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/141,680

(22) Filed: Jun. 18, 2008

(51) Int. Cl. C01B 17/90

(52) U.S. Cl. 423/531

(57) ABSTRACT

Spent sulfuric acid is decomposed by atomizing it with an oxygen-containing stream into a decomposition furnace.

### FIELD OF THE INVENTION

The present invention relates to the decomposition of spent sulfuric acid, which is carried out in the course of regenerating spent sulfuric acid.

### BACKGROUND OF THE INVENTION

Many industrial processes react or treat products with sulfuric acid. This results in the desired product, and also results in byproduct material which contains sulfuric acid and other residues. The byproduct is often termed “spent sulfuric acid”, which term is used in this application to mean material whether solid, liquid, or a mixture of solid and liquid, that contains sulfuric acid and one or more other products.

It is desirable to treat spent sulfuric acid to form therefrom fresh sulfuric acid that does not contain or greatly reduces the other products present in the spent sulfuric acid. The treatment can involve heating the spent sulfuric acid to decompose it into sulfur oxides, by which is meant sulfur dioxide, sulfur trioxide, and mixtures thereof. The sulfur oxides are used to form fresh sulfuric acid. The present invention is an advantageous method of carrying out the decomposition.

### BRIEF SUMMARY OF THE INVENTION

One aspect of the present invention is a method of decomposing spent sulfuric acid, comprising

(A) providing a flow of spent sulfuric acid which contains no combustible matter or up to a limited amount of combustible matter, and spraying the spent sulfuric acid into a decomposition furnace by atomizing said flow of spent sulfuric acid with a gaseous stream comprising at least 22 vol % oxygen;

(B) feeding fuel and air to said decomposition furnace separately from said flow of spent sulfuric acid, wherein the amount of oxygen fed in said gaseous stream and the amount of air fed to said decomposition furnace provide together at least enough oxygen to completely combust said fuel;

(C) combusting said fuel with oxygen contained in said gaseous stream and in said air in a flame to generate heat that decomposes said atomized spent sulfuric acid to form sulfur oxides and residual uncombusted solids which are in the form of fine particles not fused to the interior of said furnace, wherein said combustion forms gaseous combustion products; and

(D) recirculating said gaseous combustion products within said decomposition furnace to the base of said flame thereby reducing the flame temperature.

Another aspect of the present invention is a method of decomposing spent sulfuric acid, comprising

(A) providing a mixture of spent sulfuric acid and elemental sulfur, and spraying the mixture into a decomposition furnace by atomizing said mixture through a nozzle with a gaseous stream comprising at least 22 vol % oxygen, wherein the ratio of the mass flow rate of said gaseous stream to the mass flow rate of said mixture through said nozzle is 0.2 to 0.5;

(B) feeding fuel and air to said decomposition furnace separately from said mixture, wherein the amount of oxygen fed in said gaseous stream and the amount of air fed to said decomposition furnace provide together at least enough oxygen to completely combust said fuel;

(C) combusting said fuel with oxygen contained in said gaseous stream and in said air in a flame to generate heat that decomposes spent sulfuric acid in said mixture and combusts said elemental sulfur to form sulfur oxides and residual uncombusted solids which are in the form of fine particles not fused to the interior of said furnace, wherein said combustion forms gaseous combustion products; and

(D) recirculating said gaseous combustion products within said decomposition furnace to the base of said flame thereby reducing the flame temperature.

### BRIEF DESCRIPTION OF THE DRAWING

FIG. 1 is a cross-sectional view of a decomposition furnace in which the present invention can be carried out.

FIG. 2 is a cross-sectional view of an atomizing nozzle useful in the practice of the present invention.

### DETAILED DESCRIPTION OF THE INVENTION

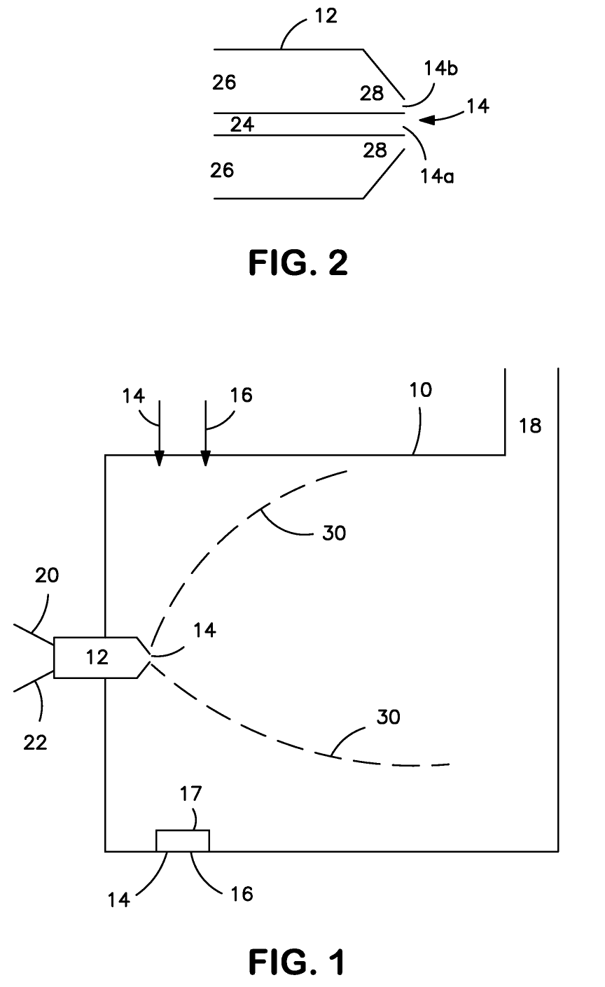

Referring to FIG. 1, decomposition furnace 10 is provided. Decomposition furnace 10 is provided with nozzle 12, terminating in orifice 14 within the decomposition furnace. Stream 20 of spent sulfuric acid and gaseous atomizing stream 22 are fed through nozzle 12 and are sprayed out of orifice 14 into decomposition furnace 10 as described below. Fuel and air for combustion of the fuel are also fed into decomposition furnace 10, separately from nozzle 12 and orifice 14. The fuel is fed through line 15, and combustion air is fed through line 16. Lines 15 and 16 can feed into decomposition furnace 10 separately from each other, or lines 15 and 16 can feed fuel and air into a burner 17 at which the fuel and air are combusted inside the decomposition furnace.

Decomposition furnace 10 should have a refractory interior lining capable of withstanding the high temperatures and the corrosive materials which characterize the environment within decomposition furnace 10 when it is being used to decompose spent sulfuric acid. Flue 18 conveys gaseous decomposition products and combustion products out of the decomposition furnace, for further treatment in any known manner to recover the thermal energy and/or to further treat sulfur oxides which are formed during the decomposition of the spent sulfuric acid.

A decomposition furnace in accordance with the present invention can contain any number of nozzles 12 to which spent sulfuric acid 20 and gaseous stream 22 are fed, but only one such arrangement is depicted in FIG. 1 for simplicity. Also there can be one or more conventional acid spray nozzles used in combination with the oxygen driven spray nozzle. Also, there can be one or more than one set of lines 15 and 16 for fuel and combustion air, and one or more than one burner 17, but only one such set and one such burner are depicted.

Nozzle 12, including orifice 14, is an atomizing nozzle, that is, it must be of a design that enables the gaseous stream 22 to impinge upon the spent sulfuric acid stream in a way that causes the stream of spent sulfuric acid as it enters decomposition furnace 10 to form a diverging pattern of atomized droplets within decomposition furnace 10. Such a spray pattern is depicted schematically as 30 in FIG. 1.

FIG. 2 illustrates one preferred embodiment of nozzle 12, in which conduit 24 through which spent sulfuric acid is fed is surrounded by a concentric passageway 26 through which gaseous stream 22 is fed. The concentric passageway 26 preferably includes region 28 whose radius decreases in the direction of flow toward orifice 14. Spent sulfuric acid emerges from outlet 14a, and the gaseous stream 22 emerges from outlet 14b. Preferably, outlets 14a and 14b are coplanar. Examples of satisfactory atomizing nozzles are well known and easily obtained in this technical field. In preferred modes of construction, the axis of nozzle 12 preferably lies along the axis of decomposition furnace 10, the better to achieve a uniform distribution of the spray pattern 30.

In operation of the present invention, spent sulfuric acid 20 and gaseous stream 22 are both fed to nozzle 12. The spent sulfuric acid is fed into decomposition furnace 10 through nozzle 12, or through all such nozzles where more than one nozzle is used, at a flow rate desired for the given unit operation so as to achieve the desired rate of decomposition of the spent sulfuric acid. The flow rate will also be affected to some extent by the physical characteristics of the spent sulfuric acid, that is, its solids content and its viscosity. However, in general suitable mass flow rates of spent sulfuric acid in the practice of this invention will yield velocities of less than 20 ft/sec out of the orifice size chosen. The selection of the spent acid orifice size depends on the physical characteristics of the spent sulfuric acid but typically has a diameter no less than 0.05 inches, typically at least 0.1 inches. The spent sulfuric acid may be free of combustible matter, or it may contain up to a limited amount of combustible components. By “limited amount” it is meant that the spent sulfuric acid does not contain enough combustible matter to support the decomposition reaction without feeding and combusting additional fuel such as natural gas, fuel oil, molten sulfur, hydrogen sulfide rich gas or another fuel, in furnace 10.

In a useful alternate embodiment, molten sulfur is fed into the spent sulfuric acid upstream of nozzle 12, to form a mixture of elemental sulfur and spent sulfuric acid that is fed through nozzle 12 into furnace 10. The elemental sulfur can comprise any portion of the mixture, preferably up to 25 wt. % or up to 50 wt. % of the mixture. The atomization of the mixture by nozzle 12 atomizes the elemental sulfur, which combusts in furnace 10. This embodiment enriches the sulfur oxides content of the gaseous combustion products that are formed in furnace 10, thus enhancing the ability to produce fresh sulfuric acid from the combustion products or to put the combustion products to other advantageous uses. This embodiment also can enable a reduction in the amount of fuel that would otherwise have to be fed via line 15 into furnace 10 for combustion, as the combustion of the elemental sulfur in furnace 10 provides heat that would otherwise have to be provided by combustion of other fuel.

The gaseous stream 22 that is fed to nozzle 12 should comprise at least 22 vol. % oxygen, and more preferably at least 50 vol. % oxygen and yet more preferably at least 80 vol. % oxygen. This gaseous stream should be fed to nozzle 12 at a mass flow rate and velocity sufficient to atomize the spent sulfuric acid as it emerges from orifice 14 into decomposition furnace 10. Typical effective velocities range from Mach 0.3 to Mach 2.0.

The ratio of the mass flow rate of the gaseous stream 22 to the mass flow rate of the spent sulfuric acid in stream 20 to any given nozzle 12 should be sufficient to atomize the flow of spent sulfuric acid as it emerges from orifice 14. Typical mass ratios range from 0.2 to 0.5 and preferably 0.25 to 0.30. It will be recognized that the velocity of the gaseous oxygen stream, and the mass flow rate of the gaseous oxygen stream, may have to be higher with increasing viscosity, and with increasing solids content, of the spent sulfuric acid flow that is to be atomized. It is also preferred to avoid impingement of the atomized spent sulfuric acid into the interior surfaces decomposition furnace 10 within the first approximately 20 feet from the orifice 14. This aspect helps reduce the risk that undecomposed spent sulfuric acid material contacts the inner surfaces of the decomposition furnace, which can lead to premature deterioration of those surfaces.

As shown in FIG. 1, fuel and air are fed to decomposition furnace 10 either via separate fuel line 15 and air line 16, or together in burners 17 to which fuel from line 15 and air from line 16 are fed to be combined and combusted at the burner outlet inside decomposition furnace 10. Suitable fuels include any combustible hydrocarbon gas or liquid, such as methane, natural gas, liquefied petroleum gas, or fuel oil; molten sulfur and/or hydrogen sulfide rich gas may also be used.

A sufficient amount of fuel is fed to decomposition furnace 10 so that combustion of the fuel generates sufficient heat inside decomposition furnace 10 to decompose the spent sulfuric acid thus forming the desired sulfur oxides. Enough fuel should be fed and combusted to establish a temperature within the decomposition furnace of at least 900 C and more preferably at least about 975 C, to assure a high degree of decomposition of the spent sulfuric acid into the aforementioned oxide of sulfur.

The amount of air fed for combustion to decomposition furnace 10 should be sufficient so that the oxygen in this air, together with the oxygen fed in stream 22 to atomize the spent sulfuric acid, constitutes sufficient oxygen to combust all of the fuel that is fed to combustion furnace 10. That is, at least a stoichiometric amount of oxygen should be provided by stream 22 and by the air fed through line 16 and/or through the one or more burners 17 that may be present, although a slight stoichiometric excess of oxygen (up to 1.2:1 as oxygen to fuel) is advantageous to ensure complete combustion of the fuel and prevent the formation of elemental sulfur. Typical values of the oxygen in the gas exiting the furnace range between 1.5% to 2.5% by volume.

The combustion of the fuel forms a flame within the decomposition furnace 10. Preferably, the flame formed by the combustion of the fuel is located with respect to the decomposition furnace so that gaseous combustion products which are produced by combustion of the fuel recirculate within decomposition furnace 10, and recirculate to the base of the flame which thereby promotes a lowering of the flame temperature, which helps to control the undesirable formation of nitrogen oxides. Recirculation is promoted by feeding the fuel and combustion air so that they enter the furnace in the turbulent regime, typically identified with Reynolds numbers above 3000, the better to entrain recirculating gaseous combustion products within the decomposition furnace.

The atomization of the spent sulfuric acid feed with oxygen as described herein provides numerous benefits. In past practices for treating spent sulfuric acid, it has been found that a solid residue of uncombusted matter remains within the furnace as a hard solid that is fused to the interior surface of the furnace. Removing this residue has conventionally required difficult and time-consuming steps such as chipping the fused residue off of the surfaces where it has formed. By contrast, it has been found that the method of this invention leaves uncombusted matter in the form of fine particles which are not fused to the interior surfaces of the furnace. These particles can easily and quickly be removed from the furnace interior, for instance by being swept out or blown out by a jet of compressed air.

Another advantage of the present invention is that the atomized acid in the conical pattern represented as 30 in FIG. 1 delivers the acid to areas within decomposition furnace 10 that might otherwise be too hot, so that the introduction of spent sulfuric acid into these areas will absorb heat by the vaporization and decomposition of the spent sulfuric acid. Moreover, atomizing the spent sulfuric acid with the gaseous stream containing oxygen in a higher amount than in air promotes immediate and close contact between the oxygen and the many droplets of the atomized spent sulfuric acid, especially as the spent sulfuric acid first enters decomposition furnace 10. This close contact helps prevent the formation of elemental sulfur as might occur in regions within decomposition furnace 10 in which the oxygen concentration of the local ambient atmosphere is too low and can provide oxygen for the combustion of any combustible species that may be present in the spent acid.

In addition, using the oxygen-containing stream 22 to atomize the spent sulfuric acid allows the amount of combustion air fed to be reduced, relative to the situation in which no gaseous oxygen is fed to the decomposition furnace. This reduction in the flow rate of combustion air results in a reduction in the amount of nitrogen fed to the decomposition furnace 10. Besides lessening the tendency to form nitrogen oxides, this also improves furnace efficiency because there is less nitrogen being fed to act as a heat sink for combustion heat that now can be directed instead to decomposition of spent sulfuric acid.

Furthermore, the use of an atomizing nozzle of the design style described here reduces the risk of encountering constriction or plugging of the orifice through which the spent sulfuric acid is fed, compared to situations in which spent sulfuric acid is fed through a conventional nozzle and orifice. That is, the orifice of the atomizing nozzle is larger, thereby lessening the risk of solids in the spent sulfuric acid constricting or clogging the orifice. The lessening in the amount of nitrogen fed with the combustion air into the decomposition furnace also enables an increase in the rate of throughput of the spent sulfuric acid, because more of the heat of combustion is available for bringing about the desired decomposition of spent sulfuric acid and less of the system volume is occupied by the inert nitrogen.

What is claimed is:

1. A method of decomposing spent sulfuric acid, comprising
(A) providing a flow of spent sulfuric acid which contains no combustible matter or up to a limited amount of combustible matter, and spraying the spent sulfuric acid into a decomposition furnace by atomizing said flow of spent sulfuric acid through a nozzle with a gaseous stream comprising at least 22 vol % oxygen, wherein the ratio of the mass flow rate of said gaseous stream to the mass flow rate of said spent sulfuric acid through said nozzle is 0.2 to 0.5;
(B) feeding fuel and air to said decomposition furnace separately from said flow of spent sulfuric acid, wherein the amount of oxygen fed in said gaseous stream and the amount of air fed to said decomposition furnace provide together at least enough oxygen to completely combust said fuel;
(C) combusting said fuel with oxygen contained in said gaseous stream and in said air in a flame to generate heat that decomposes said atomized spent sulfuric acid to form sulfur oxides and residual uncombusted solids which are in the form of fine particles not fused to the interior of said furnace, wherein said combustion forms gaseous combustion products; and
(D) recirculating said gaseous combustion products within said decomposition furnace to the base of said flame thereby reducing the flame temperature.

2. A method according to claim 1 wherein the gaseous stream with which said flow of spent sulfuric acid is atomized comprises at least 50 vol. % oxygen.

3. A method according to claim 2 wherein the ratio of the mass flow rate of said gaseous stream to the mass flow rate of said spent sulfuric acid through said nozzle is 0.25 to 0.30.

4. A method according to claim 1 wherein the gaseous stream with which said flow of spent sulfuric acid is atomized comprises at least 80 vol. % oxygen.

5. A method according to claim 4 wherein the ratio of the mass flow rate of said gaseous stream to the mass flow rate of said spent sulfuric acid through said nozzle is 0.25 to 0.30.

6. A method of decomposing spent sulfuric acid, comprising
(A) providing a mixture of spent sulfuric acid and elemental sulfur, and spraying the mixture into a decomposition furnace by atomizing said mixture through a nozzle with a gaseous stream comprising at least 22 vol % oxygen, wherein the ratio of the mass flow rate of said gaseous stream to the mass flow rate of said mixture through said nozzle is 0.2 to 0.5;
(B) feeding fuel and air to said decomposition furnace separately from said mixture, wherein the amount of oxygen fed in said gaseous stream and the amount of air fed to said decomposition furnace provide together at least enough oxygen to completely combust said fuel;
(C) combusting said fuel with oxygen contained in said gaseous stream and in said air in a flame to generate heat that decomposes spent sulfuric acid in said mixture and combusts said elemental sulfur to form sulfur oxides and residual uncombusted solids which are in the form of fine particles not fused to the interior of said furnace, wherein said combustion forms gaseous combustion products; and
(D) recirculating said gaseous combustion products within said decomposition furnace to the base of said flame thereby reducing the flame temperature.
